(19) United States
(12) Patent Application Publication
(10) Pub. No.: US 2026/0016789 A1
(43) Pub. Date: Jan. 15, 2026

(54) HOLOGRAPHIC STORAGE OPTICAL SYSTEM

(71) Applicant: Northeast Normal University, Changchun (CN)

(72) Inventors: Zhongzhu LIANG, Changchun (CN); Shencheng FU, Changchun (CN); Siyu GUO, Changchun (CN); Haiyang XU, Changchun (CN); Xiaoyan SHI, Changchun (CN); Fuming YANG, Changchun (CN); Yichun LIU, Changchun (CN)

(73) Assignee: Northeast Normal University, Changchun (CN)

(21) Appl. No.: 19/337,814

(22) Filed: Sep. 23, 2025

(30) Foreign Application Priority Data
Apr. 27, 2025 (CN) 202510534589.1

(51) Int. Cl. G03H 1/04; G02B 1/00

(52) U.S. Cl. CPC G03H 1/0465; G02B 1/002; G03H 2222/12; G03H 2222/31

(57) ABSTRACT

A holographic storage optical system, relating to the field of holographic storage optics, includes: a first metasurface provided in an optical path of a S-polarized writing light beam, configured to split the writing light beam into a first polarized light and a second polarized light exhibiting an off-axis focusing characteristic; a second metasurface provided in the optical path of the second polarized light, configured to reflect the second polarized light into parallel light; a mask with a target image provided in the optical path of the parallel light; a third metasurface provided in the optical path of the second polarized light and configured to focus the parallel light after it passes through the mask; and a photosensitive material provided at an intersection of the first polarized light and the focused polarized light. The present application simplifies the construction of the holographic storage optical system.

### RELATED APPLICATIONS

The present application claims the benefit of priority of Chinese Patent Application No. 202510534589.1, filed Apr. 27, 2025, and entitled “HOLOGRAPHIC STORAGE OPTICAL SYSTEM,” the entire content of which is incorporated herein by reference.

### TECHNICAL FIELD

The present application relates to the field of holographic storage optical technology, and particularly relates to a holographic storage optical system.

### BACKGROUND

Currently, the total amount of data is surging at a super-exponential rate, creating an urgent demand for the development of advanced information storage technology. Against this backdrop, optical storage technology has shown broad prospects and significant application value due to its notable advantages such as low energy consumption, long service life, and high-density storage. Among these, holographic optical storage technology has attracted particular attention. Based on the principles of holography, this technology employs two-beam interference to irradiate the storage medium, causing the molecular, atomic, or electronic states in the medium to undergo periodic modulation by the optical field, thereby changing the optical properties of the material. During this process, the entire page of data information is recorded in the form of alternating bright and dark fringes. These fringe information not only carries the amplitude and phase information of the light, but also encode other dimensions such as polarization, thereby enabling parallel page-wise recording. This innovative recording method overcomes the limitations of traditional bit-wise recording, significantly enhancing both the density and data processing speed of optical storage, and is therefore regarded as a strong contender for the next-generation storage technology.

In the implementation of optical storage, it is typically necessary to construct an optical path and record information through light beam interference between object light and reference light. This process often requires a complex combination of mirrors and lens barrels, resulting in an optical system that is structurally complicated and physically bulky. Given that metasurfaces are capable of flexibly modulating the amplitude, phase, and polarization of light at the subwavelength scale, they offers a highly promising solution for simplifying the structure and reducing the size of optical systems. Therefore, exploring the use of metasurface technology to realize the miniaturization of holographic storage optical systems has become a critical challenge requiring urgent resolution.

### SUMMARY

The objective of the present application is to provide a holographic storage optical system capable of simplifying the structure of the holographic storage optical system and achieving the miniaturization of the holographic storage optical system.

In order to achieve the above objective, the present application provides the following technical solution:
a holographic storage optical system, including: a first metasurface, a second metasurface, a third metasurface, a mask, a photosensitive material, and a photoelectric detection device; where the first metasurface is provided on an optical path of a writing light beam with S-polarization; the first metasurface is configured to split the writing light beam into first polarized light having a phase difference of 90° from the polarization direction of the writing light beam and second polarized light having a same polarization direction as the writing light beam and exhibiting an off-axis focusing characteristic; the second metasurface is provided in an optical path of the second polarized light; the second metasurface is configured to reflect the second polarized light into parallel light; the mask is provided in an optical path of the parallel light; the mask has a target image; the third metasurface is provided in an optical path of the second polarized light; the parallel light, after passing through the mask, is incident on the third metasurface; the third metasurface is configured to focus the parallel light emitted from the mask; the first polarized light and the focused polarized light intersect at an intersection, and the photosensitive material is provided at the intersection; and on a side of the photosensitive material, a detection light beam with a preset wavelength is incident into the photosensitive material from the intersection, and the photoelectric detection device is configured to receive a light beam exiting from the opposite side of the photosensitive material, thereby realizing the reconstruction of the hologram information.

Optionally, the first metasurface includes a first substrate, a first subwavelength array, and a second subwavelength array; the second metasurface includes a second substrate and a third subwavelength array; the third metasurface includes a third substrate and a fourth subwavelength array; the first metasurface includes a light incident side and a light exiting side; a light beam enters from the light incident side and exits from the light exiting side; the first subwavelength array and the second subwavelength array are provided in a crossed configuration on the light exiting side of the first substrate; the third subwavelength array is provided on a side of the second substrate; and the fourth subwavelength array is provided on a side of the third substrate.

Optionally, the system further includes a first laser and a second laser; the first laser is configured to provide a writing light beam with S-polarization; and the second laser is configured to provide a detection light beam with a preset wavelength.

Optionally, the photoelectric detection device includes, but is not limited to, a photodetector, a photodiode, and a charge-coupled device.

Optionally, a material of the first substrate, a material of the first subwavelength array, and a material of the second subwavelength array are all materials having light transmittance higher than preset transmittance in the visible wavelength range; the material of the second substrate is a material having reflectance higher than preset reflectance in the visible wavelength range; the material of the third substrate, the material of the third subwavelength array, and the material of the fourth subwavelength array are all materials having light transmittance higher than preset transmittance in the visible wavelength range.

Optionally, a diameter of a spot of the parallel light is greater than a diameter of a spot of the second polarized light incident on the second metasurface.

Optionally, the first subwavelength array, the second subwavelength array, and the third subwavelength array are all rectangular pillar arrays with birefringence effect or elliptical pillar arrays with birefringence effect.

Optionally, the fourth subwavelength array is a polarization-insensitive cylindrical pillar array, a rectangular pillar array with birefringence effect, or an elliptical pillar array with birefringence effect.

Optionally, wavelengths of the writing light beam and the detection light beam are different.

Optionally, the wavelength of the writing light beam ranges from the visible band to the near-infrared band.

According to specific embodiments provided by the present application, the following technical effects are disclose in the present application:

the present application discloses a holographic storage optical system, in which a first metasurface simultaneously performs beam splitting of a writing light beam and independently modulates a first polarized light and a second polarized light; a second metasurface modulates the wavefront of the second polarized light so that its expanded reflected light beam is perpendicular to a third metasurface, thereby replacing a bulky light beam expander group to achieve the light beam expansion function; the third metasurface focuses the light beam; the first polarized light intersects with the light beam focused by the third metasurface at a same spatial position in the photosensitive medium, in which optical interference occurs, thereby realizing optical storage; on a side of the photosensitive material, a detection light beam with a preset wavelength is incident into the photosensitive material from an intersection, and a photoelectric detection device is configured to receive the light beam exiting from the opposite side of the photosensitive material to obtain a hologram, thereby realizing the reading of information; and thus the present application uses metasurfaces to realize the miniaturization of the holographic storage optical systems.

### BRIEF DESCRIPTION OF THE DRAWINGS

In order to more explicitly illustrate technical solutions in the embodiments of the present application or in the existing art, a brief introduction of drawings required for the embodiments is provided below. It should be understood that the drawings described below are merely some embodiments of the present application. For those of ordinary skill in the art, other drawings may also be obtained based on these drawings without any creative effort.

FIG. 1 is an optical path diagram of a miniaturized holographic storage optical system using a metasurface provided in an embodiment of the present application.

FIG. 2 is a schematic diagram of an optical path of a first metasurface for realizing polarization modulation, off-axis focusing, and parallel emission provided in an embodiment of the present application.

FIG. 3 is a schematic diagram of an optical path of a second metasurface for expanding object light provided in an embodiment of the present application.

FIG. 4 is a schematic diagram of an optical path of a third metasurface for focusing object light provided in an embodiment of the present application.

### DETAILED DESCRIPTION

The technical solutions in embodiments of the present application will be explicitly and completely described below with reference to drawings of the embodiments. It should be understood that the embodiments described are only part of the embodiments of the present application, rather than all embodiments. All other embodiments, derived by those of ordinary skill in the art based on the embodiments of the present application without the exercise of inventive efforts, are all intended to be included within the scope of protection of the present application.

The objective of the present application is to provide a holographic storage optical system, aiming to simplify the structure of the holographic storage optical system and realize the miniaturization of the holographic storage optical system.

In order to make the above objectives, features, and advantages of the present application more apparent and understandable, the present application is further described in detail below with reference to the drawings and specific implementations.

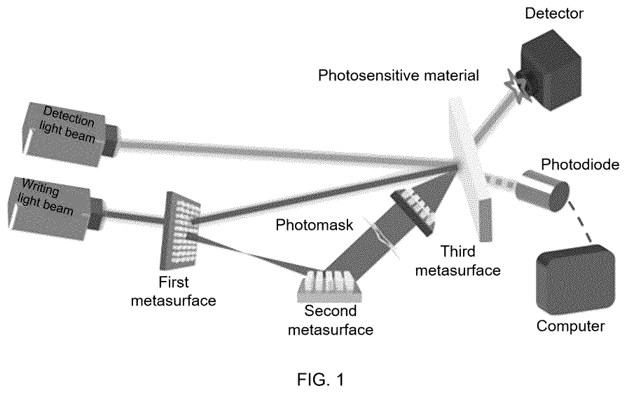

As shown in FIG. 1, a holographic storage optical system in this embodiment includes: a first metasurface, a second metasurface, a third metasurface, a mask, and a photosensitive material; where the first metasurface is provided in an optical path of a writing light beam with S-polarization; the first metasurface is configured to split the writing light beam into first polarized light having a phase difference of 90° from the polarization direction of the writing light beam and second polarized light having a same polarization direction as the writing light beam and exhibiting an off-axis focusing characteristic; the second metasurface is provided in an optical path of the second polarized light; the second metasurface is configured to reflect the second polarized light into parallel light; the mask is provided in an optical path of the parallel light; the mask has a target image; the third metasurface is provided in an optical path of the second polarized light; the parallel light, after passing through the mask, is incident on the third metasurface; the third metasurface is configured to focus the parallel light emitted from the mask; the first polarized light beam intersects with the focused polarized light beam, and photosensitive material is provided at the intersection point; and on a side of the photosensitive material, a detection light beam with a preset wavelength is incident into the photosensitive material at the intersection, and the photoelectric detection device is configured to receive a light beam exiting from the opposite side of the photosensitive material, thereby realizing the reconstruction of the hologram information. A diameter of a spot of the parallel light is greater than a diameter of a spot of the second polarized light incident on the second metasurface.

The holographic storage optical system further includes a first laser and a second laser; the first laser is configured to provide a writing light beam with S-polarization; and the second laser is configured to provide a detection light beam with a preset wavelength. The photoelectric detection device includes, but is not limited to, a photodetector, a photodiode, and a charge-coupled device.

In practical applications, after being emitted, the writing light beam with S-polarization is precisely split into two beams of light via the first metasurface, with the two beams of light exhibiting nearly identical power density. One of the beams of light, referred to as the first polarized light, is designated as reference light. The polarization state of the first polarized light is converted to P-polarization orthogonal to the original polarization through modulation by the first metasurface. Meanwhile, the first metasurface also imparts an off-axis focusing characteristic to the other beam of light, referred to as the second polarized light, which is designated as object light. After being focused, the object light gradually diverges and reaches the second metasurface. The object light is reflected into parallel light by the second metasurface and then projected onto the photosensitive material. During this process, the object light overlaps with the reference light at a same position on the photosensitive material, and interference occurs. This interference process allows the photosensitive material to record wavefront information. When a detection light beam with a low-sensitivity wavelength is irradiated onto a hologram position, a microstructure of the holographic grating induces diffraction, thereby altering the propagation properties of the light. This modulation of the readout light is closely related to the previously recorded wavefront information, thereby enabling the reproduction of the stored information.

Specifically, the photosensitive material, as the recording medium of the holographic storage optical system, is capable of recording interference patterns and storing data through the action of light. A photomask is configured to modulate the light beam during the recording process to generate a specific light field distribution, thereby forming a hologram in the photosensitive material. The photoelectric detection device is configured to receive and detect a light signal read from the storage medium, and convert it into an electric signal for further processing. The writing light beam is typically emitted by a laser with a wavelength in the visible range, such as 532 nm or 633 nm. The detection light beam is configured to read data stored in the photosensitive material. The detection light beam is irradiated onto the storage medium to reconstruct the stored hologram. The wavelength of the detection light beam should be outside the photosensitive band of the recording medium to avoid triggering a photochemical reaction that may lead to information erasure. Therefore, a wavelength of 780 nm or 830 nm can be selected.

The reference light and the focused object light intersect at an intersection, and the photosensitive material is provided at the intersection; and the object light and the reference light interfere at the intersection, forming a hologram that is recorded in the photosensitive material.

During information readout, the detection light beam with a preset wavelength is incident on the photosensitive material from the intersection, and the photoelectric detection device is configured to receive the light beam emitted from the photosensitive material from the other side opposite to the incident side of the detection light beam. The hologram is reconstructed and converted into an electric signal by the detection device, and finally processed and decoded by a computer.

In the present application, the splitting of the writing light beam can be achieved solely through the use of the first metasurface, which also enables precise modulation of the polarization characteristics of the reference light and the wavefront of the object light, respectively. Therefore, when the two beams of light exit the first metasurface, each exhibits distinct response characteristics: the reference light shows a certain deflection angle and phase delay relative to the writing light beam, while the object light possesses both a deflection angle and focusing characteristics. The second metasurface alone enables the parallel emission of the divergent light beam after focusing, thus achieving a beam expansion effect. The third metasurface is configured to focus the light beam.

The first metasurface can independently modulate the object light and the reference light while splitting the light beam. For the reference light, a desired phase difference can be introduced when it exits the metasurface; and for the object light, off-axis focusing can be achieved when it exits the metasurface. The second metasurface can modulate the wavefront of the divergent object light so that its expanded reflected light beam is perpendicular to the metasurface, thereby replacing a bulky beam expander group to achieve the light beam expansion function. The third metasurface focuses the object light. The reference light and the object light focused by the third metasurface overlap at a same spatial position in the photosensitive medium, in which optical interference occurs, thereby realizing optical storage. The present application uses metasurfaces to realize the miniaturization of the holographic storage optical systems.

The present application successfully integrates functions that traditionally require multiple mirrors to work together into a single mirror through the design of the first metasurface, the second metasurface, and the third metasurface structure and their outstanding capabilities in wavefront modulation. In addition, a single metasurface replaces a complex beam expansion apparatus, greatly simplifying the system architecture and significantly reducing its overall size.

The operation process of a holographic storage optical system provided by the present application is as follows:
A writing light beam is a linearly polarized light beam with s-polarization. Upon passing through a first metasurface, the light beam is split into two polarized light beams with a constant phase difference. One of the two polarized light beams, with a polarization direction perpendicular to an original writing light beam, is referred to as reference light. The reference light is polarized along p direction and projected onto a photosensitive material at a specific deflection angle. This step ensures that the reference light and subsequent object light can achieve precise interference on the photosensitive material. Another beam of the two polarized light beams, referred to as object light, remains polarized along s direction. However, after the modulation by the first metasurface, the wavefront of the object light is converted into a spherical wavefront. This conversion is essential for the subsequent off-axis focusing and recording of holographic information. The object light undergoes off-axis focusing at a specific location and continues to diverge after passing through the focal point. Finally, the divergent object light reaches a second metasurface.

The second metasurface finely modulates the wavefront of the divergent object light, reshaping the wavefront of the object light and reflecting the light at a specific reflection angle. After modulation by the second metasurface, the object light is converted into parallel light, and a light spot diameter is significantly expanded. At this time, a mask with a diameter close to the expanded light spot diameter is placed in an optical path behind the second metasurface. Subsequently, the object light carrying MASK information is further focused by the third metasurface. The photosensitive material is placed near the focal point of the third metasurface. At this location, the object light overlaps with the reference light on the photosensitive material, and optical interference occurs. This interference process records holographic information at a specific spatial position on the photosensitive material. This information exists in the form of microscopic grating fringes, which carry the phase difference and amplitude information between the object light and the reference light, and serve as the core mechanism of holographic storage technology.

During the information readout stage, a low-sensitivity light beam with a specific wavelength is used to irradiate the location of the hologram. This light beam is referred to as a detection light beam. This light beam is chosen to avoid unnecessary interference or damage to the photosensitive material, while ensuring effective excitation of the information embedded in the hologram. When this light beam with a low-sensitivity wavelength is irradiated onto the hologram, diffraction occurs based on the microstructural characteristics of the holographic grating. These microstructures are grating fringes formed on the photosensitive material by the interference between the object light and the reference light during the holographic information recording process. Functioning like miniature optical components, these structures exert a significant influence on the propagation properties of the incident light. Specifically, when the readout light interacts with the microstructure of the holographic grating, the propagation path of the light alters, generating a specific diffraction pattern. This diffraction pattern is not generated randomly, but is closely correlated with the information recorded in the hologram. In essence, the microstructures of the holographic grating actually act as a modulator, precisely modulating the amplitude, phase, polarization, and other properties of the readout light. Based on this modulation of the readout light, the information stored in the hologram can be reproduced. When the readout light passes through the hologram, the resulting diffraction pattern will carry the features of the original information. Through appropriate detection means, these diffraction patterns can be captured, analyzed, and reconstructed to retrieve the original stored information content. The detection means can be selected from photodetectors, photodiodes, CMOS sensors, among others, which transmit the detected hologram to a computer.

The present application relies on the integration capability and flexible wavefront modulation by the first metasurface to independently impart the required phase to both the reference light and the object light, while refracting the reference light and the object light at different deflection angles.

The second metasurface proposed in the present application can reflect a divergent light beam from one side as parallel light toward the other side. The object light passing through the second metasurface exhibits an expanded light beam diameter.

As a specific implementation, a first metasurface includes a first substrate, a first subwavelength array, and a second subwavelength array; the first metasurface includes a light incident side and a light exiting side; a light beam enters from the light incident side and exits from the light exiting side; and the first subwavelength array and the second subwavelength array are provided in a crossed configuration on the light exiting side of the first substrate.

As a specific implementation, a material of a first substrate, a material of a first subwavelength array, and a material of a second subwavelength array are all materials having light transmittance higher than preset transmittance in the visible wavelength range.

As a specific implementation, a first subwavelength array is a rectangular pillar array with birefringence effect or an elliptical pillar array with birefringence effect, and a second subwavelength array is a rectangular pillar array with birefringence effect or an elliptical pillar array with birefringence effect.

As a specific implementation, a second metasurface includes a second substrate and a third subwavelength array; the third subwavelength array is provided on a side of the second substrate; and a material of the second substrate is a material having reflectance higher than preset reflectance in the visible wavelength range. The material of the third subwavelength array is a material having transmittance higher than preset transmittance in the visible wavelength range.

As a specific implementation, the third metasurface includes a third substrate and a fourth subwavelength array; the fourth subwavelength array is provided on a side of the third substrate; a material of the third substrate and a material of the fourth subwavelength array are both materials having transmittance higher than preset transmittance in the visible wavelength range.

As a specific implementation, wavelengths of a writing light beam and a detection light beam are different. The wavelength of the writing light beam ranges from the visible band to the near-infrared band.

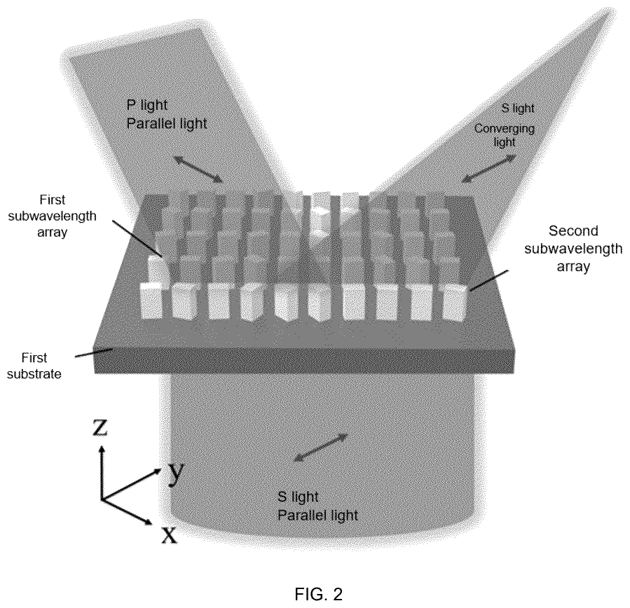

As shown in FIG. 2, a first metasurface includes a plurality of unit structures arranged periodically; the plurality of unit structures include a plurality of first unit structures and a plurality of second unit structures; and the first unit structures and the second unit structures are arranged in a cross-distributed manner. When light passes through the first metasurface, a first subwavelength array controls the deflection of a reference light beam while introducing a corresponding phase difference, and the second subwavelength array controls the deflection and focusing of object light. The first metasurface is composed of a first substrate, a first subwavelength array, and a second subwavelength array, where the first subwavelength array and second subwavelength array are placed in a crossed configuration on a same side of the substrate. For example, S-polarized parallel light is incident from a side of the first metasurface that is not provided with unit structures and exits from the other side provided with unit structures, thereby obtaining P-polarized parallel light and S-polarized converging light. The first subwavelength array is a plurality of first unit structures arranged periodically; and the second subwavelength array is a plurality of second unit structures arranged periodically. In the XYZ coordinate system, it can be intuitively observed that the polarization directions of S-polarized parallel light, the P-polarized parallel light, and the S-polarized converging light are different.

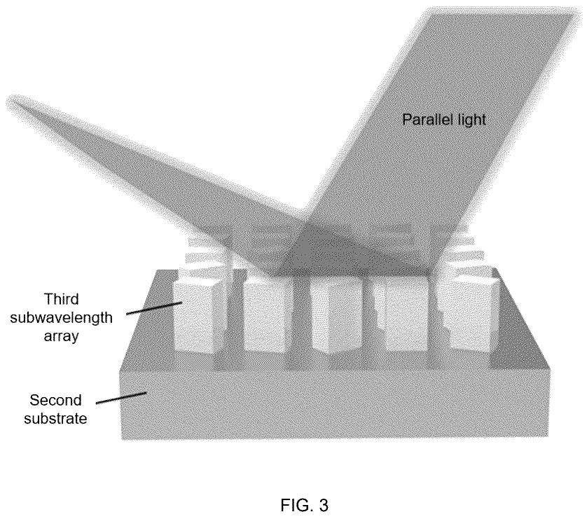

As shown in FIG. 3, phase and amplitude information imparted by a second metasurface alters a wavefront shape and propagation direction of object light, and the object light passing through the second metasurface exhibits an expanded light beam diameter. The second metasurface is composed of a second substrate and a third subwavelength array. The third subwavelength array is periodically provided on a side of the second substrate. The third subwavelength array includes a plurality of third unit structures; and the plurality of the third unit structures are periodically provided on a side of the second substrate. The second substrate is a highly reflective substrate. The third subwavelength array is a rectangular pillar array with birefringence effect or an elliptical pillar array with birefringence effect. Materials of the second substrate are all high reflectance materials in the visible wavelength range. Materials with high reflectance in the visible wavelength range include metals such as Au, Ag, Cu, Al, Mg, and Mo. After the converging light is reflected by the second metasurface, parallel light is obtained. The material of the third subwavelength array is a material having high transmittance in the visible wavelength range.

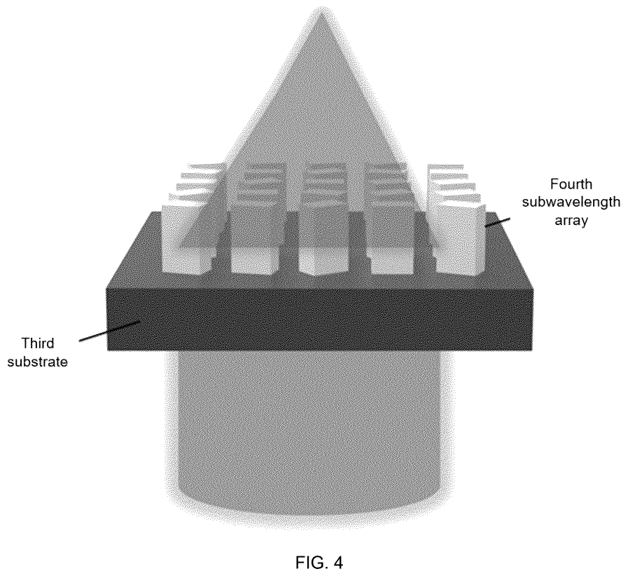

As shown in FIG. 4, a third metasurface is composed of a third substrate and a fourth subwavelength array. The fourth subwavelength array is periodically provided on a side of the third substrate. Parallel light is incident from one side of the third metasurface and exits from the other side where the fourth subwavelength array is provided, thus obtaining converging light.

As a specific implementation, a first substrate, a first subwavelength array, a second subwavelength array, a third substrate, and a fourth subwavelength array are all made of materials having high transmittance in the visible wavelength range. Materials with high transmittance in the visible range include SiO₂, Ta₂O₅, TiO₂, ITO, AZO films, PMMA, PC, and other materials. Both the first substrate and the third substrate are transparent substrates. Both the first subwavelength array and the second subwavelength array are rectangular pillar or elliptical pillar arrays with birefringence effect. The fourth subwavelength array is a polarization-insensitive cylindrical pillar array, a rectangular pillar array with birefringence effect, or an elliptical pillar array with birefringence effect.

As a specific implementation, length and width of each unit structure in the first subwavelength array, the second subwavelength array, the third subwavelength array, and the fourth subwavelength array are smaller than the operating wavelength of the holographic storage optical system.

The present application aims to address the challenges of complexity currently faced by holographic storage optical systems by proposing a holographic storage optical system solution. The core of this solution lies in the ingenious utilization of metasurfaces offering precise and efficient control over the electromagnetic properties of light waves. Based on this capability, the system achieves a high degree of functional integration and a significant simplification of its structural design. Specifically, the present application draws on the advanced design concept of Huygens electromagnetic metasurfaces and selects dielectric artificial atoms with high transmittance and flexible phase modulation capabilities as the basic units for constructing the metasurfaces. These carefully designed unit structures not only ensure the efficient transmission of lightwaves, but also enable the realization of complex optical functionalities.

In the present application, the first metasurface can not only realize precise beam splitting of object light and reference light, but also introduce a specific phase difference to the reference light by finely modulating its structure, while effectively converging the object light. This design cleverly eliminates the need for multiple cooperating optical elements as required in traditional holographic storage systems, thereby significantly improving system integration and efficiency. Furthermore, the present application uses a second metasurface to replace the bulky and structurally complex beam expander typically used in the traditional optical systems, and the beam expansion function can be realized solely through the second metasurface. This innovation not only significantly reduces the size and weight of the systems, but also lowers manufacturing costs and maintenance difficulties, paving a new way for the widespread application of holographic storage optical systems.

In summary, the introduction of the present application successfully solves the complexity issues in holographic storage optical systems. The selected dielectric material with high transmittance effectively reduces energy loss. In addition, its relatively simple fabrication process offers a highly promising method for realizing multifunctional subsurface devices and further simplifying optical systems. This innovative achievement not only promotes the development of holographic storage technology, but also has a profound impact on the field of optical engineering, indicating that the future design and manufacturing of optical systems will trend toward greater miniaturization, integration, and intelligence.

The technical features described in the above embodiments can be combined in any suitable manner. For concise description, not all possible combinations of the technical features in the above embodiments have been exhaustively described. However, as long as there is no contradiction between the combinations of these technical features, they shall be considered to fall within the scope of this specification.

Specific examples have been provided herein to illustrate the principles and implementation methods of the present application. The description of the above embodiments is intended solely to aid in understanding the methodology and core concepts of the present application. For those of ordinary skill in the art, various modifications in implementation and application scope may be made based on the ideas of the present application. Therefore, the content of this specification should not be understood as limiting the scope of the present application.

What is claimed is:

1. A holographic storage optical system, comprising: a first metasurface, a second metasurface, a third metasurface, a mask, a photosensitive material, and a photoelectric detection device; wherein
the first metasurface is provided in an optical path of a writing light beam with S-polarization; the first metasurface is configured to split the writing light beam into first polarized light having a phase difference of 90° from the polarization direction of the writing light beam and second polarized light having a same polarization direction as the writing light beam and exhibiting an off-axis focusing characteristic;
the second metasurface is provided in an optical path of the second polarized light; the second metasurface is configured to reflect the second polarized light into parallel light;
the mask is provided in an optical path of the parallel light, and the mask has a target image;
the third metasurface is provided in an optical path of the second polarized light; the parallel light, after passing through the mask, is incident on the third metasurface; the third metasurface is configured to focus the parallel light emitted from the mask;
the first polarized light and the focused parallel light intersect at an intersection, and the photosensitive material is provided at the intersection; and
on one side of the photosensitive material, a detection light beam with a preset wavelength is applied to enter the photosensitive material from the intersection point, and the photoelectric detection device is applied to receive the light beam emitted from the other side opposite to one side of the photosensitive material, so as to realize the reproduction of hologram information.

2. The holographic storage optical system according to claim 1, wherein the first metasurface comprises a first substrate, a first subwavelength array, and a second subwavelength array; the second metasurface includes a second substrate and a third subwavelength array; the third metasurface includes a third substrate and a fourth subwavelength array;
the first metasurface includes a light incident side and a light exiting side; a light beam enters from the light incident side and exits from the light exiting side; the first subwavelength array and the second subwavelength array are provided in a crossed configuration on the light exiting side of the first substrate;
the third subwavelength array is provided on a side of the second substrate; and
the fourth subwavelength array is provided on a side of the third substrate.

3. The holographic storage optical system according to claim 1, further comprising: a first laser and a second laser; wherein
the first laser is configured to provide a writing light beam with S-polarization; and
the second laser is configured to provide a detection light beam with a preset wavelength.

4. The holographic storage optical system according to claim 1, wherein the photoelectric detection device includes, but is not limited to, a photodetector, a photodiode, and a charge-coupled device.

5. The holographic storage optical system according to claim 2, wherein a material of the first substrate, a material of the first subwavelength array, and a material of the second subwavelength array are all materials having light transmittance higher than preset transmittance in the visible wavelength range;
a material of the second substrate is a material having reflectance higher than preset reflectance in the visible wavelength range; and
a material of the third substrate, a material of the third subwavelength array, and a material of the fourth subwavelength array are all materials having light transmittance higher than preset transmittance in the visible wavelength range.

6. The holographic storage optical system according to claim 1, wherein a diameter of a spot of the parallel light is greater than a diameter of a spot of the second polarized light incident on the second metasurface.

7. The holographic storage optical system according to claim 2, wherein the first subwavelength array, the second subwavelength array, and the third subwavelength array are all rectangular pillar arrays with birefringence effect or elliptical pillar arrays with birefringence effect.

8. The holographic storage optical system according to claim 3, wherein the fourth subwavelength array is a polarization-insensitive cylindrical pillar array, a rectangular pillar array with birefringence effect, or an elliptical pillar array with birefringence effect.

9. The holographic storage optical system according to claim 1, wherein wavelengths of the writing light beam and the detection light beam are different.

10. The holographic storage optical system according to claim 1, wherein the wavelength of the writing light beam ranges from the visible band to the near-infrared band.
